(19) United States
(12) Patent Application Publication
(10) Pub. No.: US 2006/0012257 A1
(43) Pub. Date: Jan. 19, 2006

(54) Small electric motor and housing

(75) Inventors: Klaus Pfendler, Bonndorf (DE); Gerhard Tascher, Bonndorf (DE); Knut Gerlich, Bad Durrheim (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/153,406

(22) Filed: Jun. 16, 2005

(30) Foreign Application Priority Data
Jun. 17, 2004 (DE) 202004009587.4

(51) Int. Cl. H02K 5/00

(52) U.S. Cl. 310/89

(57) ABSTRACT

An additional housing is flanged onto the motor housing of a small electric motor, in particular a motor for the automation of a door, which motor has a flanged-on gear-unit housing, wherein the additional housing is flanged onto the motor housing in the longitudinal direction of the motor and has at least two through-bores which extend parallel to one another and perpendicularly to the longitudinal direction of the motor, and wherein the ends of the through-bores have flat bearing surfaces which lie perpendicularly to the through-bores.

### BACKGROUND OF THE INVENTION

The invention is based on the priority of German Utility Model 202004009587.4 which is hereby incorporated by reference.

The invention relates to a small electric motor with a motor housing and an additional housing which is flanged onto said motor housing in the longitudinal direction of the motor, in particular a motor for the automation of a door, which motor has a flanged-on gear-unit housing and to a housing with a flange for flanging onto a small electric motor in the longitudinal direction of said motor.

Small electric motors, for instance ones for the drives of blinds or for door-openers, are usually already supplied ready for fitting, so that the necessary gear unit is already preassembled. As a rule, said gear unit is contained in a separate housing which is flanged onto the motor housing in the longitudinal direction of said motor.

Small electric motors of this kind are often also provided with an electronic motor-activating unit, which is likewise fixedly connected to the motor. Separate housings, which are preferably likewise flanged onto the motor housing in the longitudinal direction of said motor, are also suitable for this purpose.

Because of the very compact structure of electric motors, their housings offer only little latitude for locating fastening bores or flanges for fastening purposes.

### SUMMARY OF THE INVENTION

The underlying object of the invention is to indicate a fastening possibility for arrangements of this kind.

This object is achieved, according to the invention, by means of a small electric motor with a motor housing and an additional housing which is flanged onto said motor housing in the longitudinal direction of the motor, in particular a motor for the automation of a door, which motor has a flanged-on gear-unit housing, wherein the additional housing has at least two through-bores which extend parallel to one another and perpendicularly to the longitudinal direction of the motor, and that the ends of the through-bores have flat bearing surfaces which lie perpendicularly to said through-bores.

This object is further achieved by means of a housing with a flange for flanging onto a small electric motor in the longitudinal direction of said motor, in particular a gear-unit housing for a motor for the automation of a door,

characterized in that the housing has at least two through-bores which extend parallel to one another and perpendicularly to the longitudinal direction of the motor, and that the ends of the through-bores have flat bearing surfaces which lie perpendicularly to said through-bores.

The invention is based, on the one hand, on the fact that a gear-unit housing or a housing for the electronics of a motor has more design possibilities and more latitude than a motor housing. It is based, on the other hand, on the fact that a screw-type fastening with a flat bearing surface permits simple fitting.

Further refinements of the invention can be inferred from the subclaims and the following description.

### BRIEF DESCRIPTION OF THE DRAWINGS

The invention will be explained further below, with the aid of the accompanying drawings, in which:

FIG. 1 shows a small electric motor according to the invention, with a housing according to the invention, in various views and sections; and

FIG. 2 shows, represented in perspective, a housing according to the invention, flanged onto a small electric motor.

### DETAILED DESCRIPTION OF THE DRAWINGS

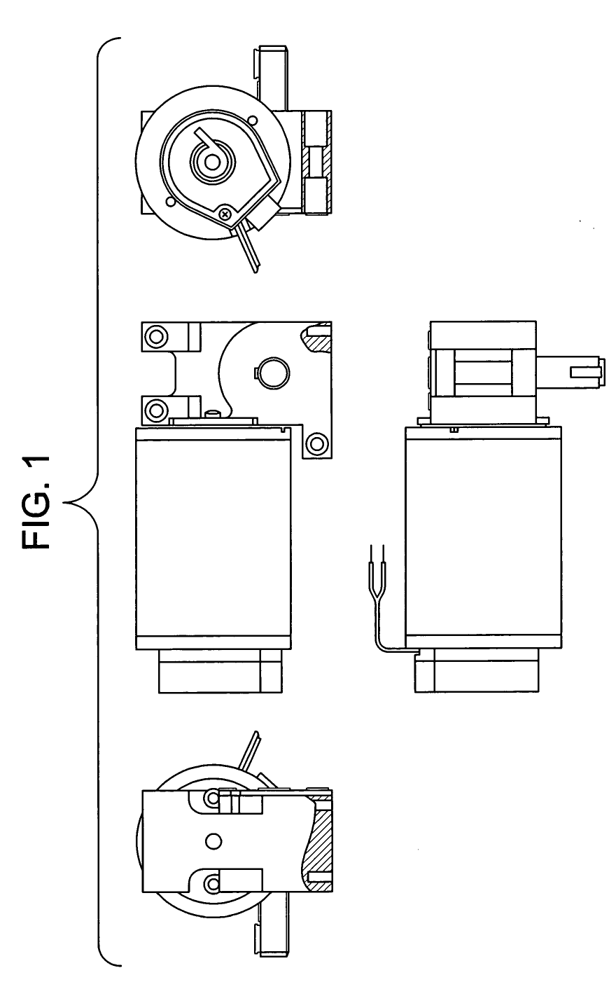

FIG. 1 shows a small electric motor according to the invention with a flanged-on gear unit. The representation in the centre at the top shows a view from the front, a view from the left is represented on the right, and a view from the right is represented on the left. Said views are partially cut away. Represented underneath them is a top view.

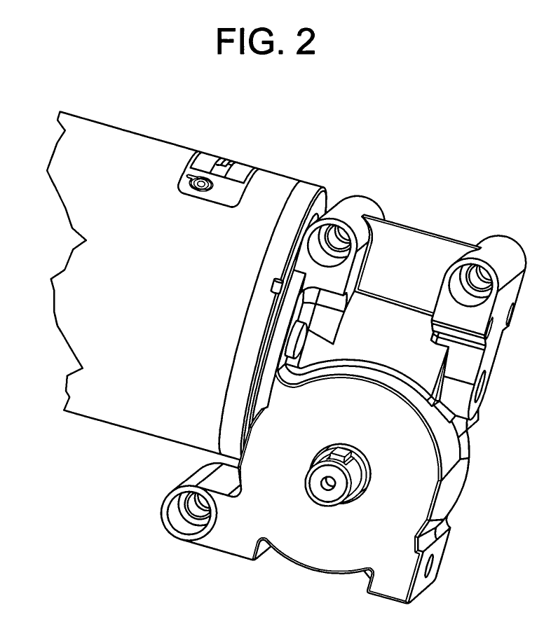

FIG. 2 shows a very similar example, represented in perspective.

The motor housing itself is circular, in a manner corresponding to the internal structure of an electric motor. The left-hand end carries a bearing plate with a cap with the electrical connections, and the right-hand end carries a bearing plate onto which a gear unit is flanged. Although both the cap with the electrical connections and also the gear unit are fitted onto the motor in the longitudinal direction of the latter, they nevertheless do not have a circular shape, as the motor does. There is more latitude here as regards design. However, the end with the electrical connections is less suitable for fastening purposes, whereas the gear-unit end on the one hand has sufficient latitude as regards design, and on the other hand is far more suitable for the fastening of the whole arrangement. Even the outer shape of the motor housing still has latitude as regards design. In particular, housings which are substantially square are also common, as well as round motor housings, and even any shapes whatsoever would be conceivably possible. However, motors are not normally adapted to specific applications but, on the contrary, use is normally made of motors originating from fairly large series.

As is shown, in particular, by the view according to FIG. 2, the gear-unit housing is now developed in such a way that it has three through-bores. In both examples, said through-bores are parallel to one another. The ends of the through-bores each have flat bearing surfaces which lie perpendicularly to said through-bores.

In both the exemplified cases, the gear-unit housing is constructed in such a way that there lies, on each of the two sides of the plane containing the axis of the motor, a plane which is parallel to the said plane and in which there lie both the ends of the through-bores and also other surfaces of the gear-unit housing. Apart from the output shaft of the gear unit, no part of the latter, and in particular no part of the gear-unit housing, protrudes beyond the said planes. However, it is not uncommon to provide contoured sections that protrude in a suitable manner for the purposes of centring or other adjustment.

It would not be necessary for the two bearing planes to lie, as in the two examples, symmetrically to the plane containing the axis of the motor. It is thereby also possible, depending upon the form of embodiment, to provide still other fastening possibilities.

Further adaptation, for instance to specific fitting rails, may also take place as a result of the parts that carry the through-bores having different lengths.

It is also possible to achieve a countersunk arrangement of the screw heads by graduating the diameters of the through-bores. A graduation of this kind is shown in FIG. 1 in the right-hand view, in section, of the through-bores on a contoured section of the base of the gear unit.

The flange on the gear-unit housing for flanging onto the motor housing can also be clearly seen in FIG. 2.

1. Small electric motor with a motor housing and an additional housing which is flanged onto said motor housing in the longitudinal direction of the motor, in particular a motor for the automation of a door, which motor has a flanged-on gear-unit housing, wherein the additional housing has at least two through-bores which extend parallel to one another and perpendicularly to the longitudinal direction of the motor, and wherein the ends of the through-bores have flat bearing surfaces which lie perpendicularly to said through-bores.

2. Small electric motor according to claim 1, characterized in that the diameters of the through-bores are graduated in such a way that screws can be passed through from each side in such a way that their heads are disposed in a countersunk manner.

3. Small electric motor according to claim 1, characterized in that all the bearing surfaces lie symmetrically to a plane containing the axis of the motor.

4. Small electric motor according to claim 1, characterized in that all the through-bores are of equal length.

5. Housing having a flange for flanging onto a small electric motor in the longitudinal direction of said motor, in particular a gear-unit housing for a motor for the automation of a door, which housing has at least two through-bores which extend parallel to one another and perpendicularly to the longitudinal direction of the motor, and in which the ends of the through-bores have flat bearing surfaces which lie perpendicularly to said through-bores.

6. Housing according to claim 5, characterized in that the diameters of the through-bores are graduated in such a way that screws can be passed through from each side in such a way that their heads are disposed in a countersunk manner.

7. Housing according to claim 5, characterized in that all the bearing surfaces lie symmetrically to a plane containing the axis of the motor.

4. Housing according to claim 5, characterized in that all the through-bores are of equal length.
